(19) United States
(12) Patent Application Publication
(10) Pub. No.: US 2010/0326151 A1
(43) Pub. Date: Dec. 30, 2010

(54) Enhanced Fertilizer Granule

(75) Inventors: Daniel Paul Madigan, Green Bay, WI (US); Ronald Dean Eichhorn, Green Bay, WI (US)

Correspondence Address: WEISS & WEISS, Suite 251, 300 Old Country Road, Mineola, NY, 11501, US

(73) Assignee: FEECO INTERNATIONAL, INC.

(21) Appl. No.: 12/456,867

(22) Filed: Jun. 24, 2009

(51) Int. Cl. C05F 11/08; C05D 1/00; C05D 9/00; C05F 1/00; C05F 11/00; C05D 9/02

(52) U.S. Cl. 71/8; 71/12; 71/25; 71/15; 71/1; 71/54; 71/32; 71/61; 71/31; 71/62; 71/17; 71/23; 71/27

(57) ABSTRACT

An enhanced fertilizer product comprised of nutrients and inert solids wherein the nutrients and inert solids are derived from a source material. The nutrients in the source material are collected with a nutrient capture process. The fertilizer product is agglomerated.

### BACKGROUND OF THE INVENTION

1. Field of the Invention

The present invention relates to a fertilizer product comprised of inert solids and nutrients and a method of making the same. The present invention concerns chemical compositions, methods and apparatus for separating a waste stream into a solids component and a water component by a nutrient capture process.

2. Description of Prior Art

A. Separating Solids from a Liquid or Solid Suspension

The use of chemicals for binding colloidal fines and solids in a suspension is well known in the art. U.S. Pat. No. 3,994,806 discloses a composition comprising a 5 to 20 percent aqueous solution of a mixture of dimethyl diallyl ammonium chloride homopolymer and polyacrylamide in a weight ratio of from 10 to 1 to 20 to 1. In the flocculation and removal of suspended matter from water, combinations of cationic and nonionic water-soluble polymers are found to be more effective than equivalent concentrations of cationics alone, and significantly lower concentrations of the combination are found to be equivalent in effect to higher concentrations of cationic polymers alone. U.S. Pat. No. 4,931,190 is directed to a method for dewatering thin slurries of very fine clay or clay-like material to yield high solids content filter cake, for example, 40% solids and greater, by the use of flocculating agent combinations involving polyethylene oxide-type flocculating agents and polyacrylamide-type flocculating agents. The method generally involves admixing the combination of flocculating agents with the slurry, dewatering the slurry by means of a mechanical dewatering apparatus and feeding the thickened slurry to a belt press filter. U.S. Pat. No. 5,213,693 teaches a novel composition comprising a dry blend of the two polymers that can be formed to provide a combined solution for mixing with a suspension. The composition is used on sewage sludge and other organic suspensions for filter press or belt press dewatering by substantially simultaneous treatment with a cationic coagulant polymer and a cationic flocculant polymer. In U.S. Pat. No. 5,846,433, a suspension is dosed with a coagulant and then with a flocculant and is dewatered to form a thickened sludge or cake and separated liquor, and control of the dewatering performance is improved by adding the flocculant at a predetermined dosage, monitoring the charge in the separated liquor (or monitoring other dewatering parameter of the separated liquor or suspension) and adding coagulant at a dosage selected in response to the monitored charge or other parameter value in order to maintain the value substantially at a pre-selected optimum value. U.S. Pat. No. 6,805,803 discloses a process of flocculating and dewatering an aqueous suspension of suspended solids comprising (a) a concentrated polymer solution and, (b) a dilute polymer solution, characterized in that the concentrated and dilute polymer solutions are introduced into the substrate substantially simultaneously. Preferably the concentrated and dilute polymer solutions are introduced into the suspension as an aqueous composition comprising a dilute aqueous solution of polymer and a concentrated solution of polymer. The process brings about improvements in filtration and cake solids.

B. Separating Solids from Liquid Manure

Manure is hazardous to humans, animals and the environment. Untreated manure, typically containing animal feces and urine, is a perfect medium for the proliferation of microbes and parasites. Manure also emanates gases produced by decomposition such as hydrogen sulfide, methane, ammonia, and carbon dioxide. These gases not only produce a foul smell, but, in high enough concentrations, each of these gases may pose a health threat to humans and livestock. Manure runoffs also pose a contamination threat to rivers, streams and groundwater.

Farms have several options for manure management: solid material handling, slurry handling, liquid manure handling, treatment in an anaerobic lagoon, composting, and a combination of these. One of the more common management practices is to collect the manure in large lagoons or digesters where the manure is treated with anaerobic bacteria that digest organic matter by liquefying it and then converting it primarily into carbon dioxide, methane, ammonia, and hydrogen sulfide. The manure, typically between 1% to about 5% solids, and most typically to about 2% solids, is relatively easy to handle and can be disposed of in crop field irrigation. The manure can also be handled by using conventional irrigation equipment and without the need to use special pumps. Disposal through irrigation normally carries a low risk of contaminating the ground water in situations where the soil is sufficiently thick to filter out these contaminants before reaching the ground water. Slurry manure, i.e. manure with a solids content of about 5% to about 7%, is more difficult to handle and requires special pumps and irrigation equipment.

There are several disadvantages to using liquid manure in this fashion, however. 1) The valuable nutrients and minerals in the manure are not being effectively utilized, 2) It requires expensive storage and handling equipment, 3) A large quantity of water is locked in with the manure and can not be beneficially used, 4) In northern states the ground is frozen during the winter months and irrigation can not be used to dispose of the liquid manure since it would cause runoffs that could contaminate rivers and streams and 5) Ground water contamination can occur where the soil is not very effective in filtering out the contaminants contained in the stream.

Manure is a foul smelling mixture of about 98% water and 2% solids. The solids portion contains valuable nutrients and minerals most notably phosphates and nitrates suspended in a colloidal state. It would be therefore desirable to recover these components for use in fertilization and to release clean and usable water.

Attempts to separate manure solids material from liquids in the past included mechanical means, chemical means or a combination of the two. Mechanical separation means alone have a low separation efficiency as the colloidal fines tend to stay with the liquid portion. Combinations of mechanical and chemical separation methods have had more success but generally required slow and expensive multiple batch floatation stages in order to achieve the required high separation efficiencies.

U.S. Pat. No. 6,749,068 describes a separation process using a sloped screen of small openings and using air flow to enhance liquid drainage. U.S. Pat. Nos. 5,205,930 and 6,651,822 are directed toward a mechanical separator pressing the solids using a screw feeder. U.S. Pat. No. 5,268,100 discloses liquid slurry introduced at a top in-feed end of the screen and moved downwardly along the in-feed section of the screen by a paddle conveyor. Separation of solids occurs primarily along the in-feed screen section. The slurry is then moved angularly upwardly along the discharge section of the screen for final dewatering.

Chemical additives used to effect the agglomeration of particles onto solids material were coagulant flocculant chemicals known in the art such as aluminum sulfate, calcium hydroxide, calcium carbonate, calcium sulfate, anionic polymers, and cationic polymers such as polyacrylamide. For example, U.S. Pat. No. 4,079,003 teaches the use of longitudinally spaced paddles for moving and agitating a mixture, particularly when the minimum solids concentration is in excess of 25%, so as to achieve an agglomeration of solids into a solid friable material, largely as a result of large quantities of lime to generate heat and cause dehydration and solidification. U.S. Pat. No. 5,401,402 discloses a method of treating sewage sludge, in which the sludge is mixed with an alkaline material in such a way as to provide intimate surface contact that enables the alkaline material to permeate even small particles of the sludge, and to deliver the resultant product in a granular form. The sludge and alkaline material are delivered to a mixing chamber and are confronted therein with a screw type mixer having generally helical flighting carried by a shaft, with the mixer being rotatably driven in generally horizontal arrangement to convey the mixture toward an outlet. U.S. Pat. No. 6,824,691 discloses a process for treating liquid manure with a tertiary or quaternary polyacrylamide in an amount of between 80 ppm and 140 ppm and stirring for a time ranging from 5 to 15 minutes to flocculate the colloidal suspension onto the solids. The solids are separated from the liquid by floatation. U.S. Pat. Nos. 5,785,730 and 5,776,350 disclose a method for separating raw agricultural waste into a liquid portion and a nutrient enriched solids portion by adding an effective amount of a quaternized amino methylated polyacrylamide polymer, mixing the polymer with the raw agricultural waste, subjecting the mixture to at least one mechanical separation means, and separately collecting the liquid and the solids portions. Pre-grant publication No. 20050000906 discloses a method of treating animal manure using a biological passive flotation step in a flotation unit having a hydraulic residency time (HRT) of about 4 to about 24 hours with a polymer followed by a skimming means for removing floating solids from at least a portion of the surface of the manure. This is followed by a secondary floatation and skimming step having a residence time of 0.5-4 hours. The claims of the publication are directed to the use of a polymer with the preferred embodiment of a polyacrylamide. Pre-grant publication No. 20060108291 teaches a method of treating manure comprising: a) mixing a quantity of manure with lime such that said mixture has a basic pH; b) adding a first coagulating polymer to said mixture, thereby promoting floc formation within said mixture; c) separating the floc from the mixture, thereby forming solids and a liquid portion; d) adding a second coagulating polymer and/or a struvite-promoting compound to said liquid portion, thereby forming solids and clear liquid; and e) separating the clear liquid from the solids.

The present invention involves the removal of water from suspensions containing colloidal fine particles that results in a high solids portion and water that contains a very small amount of these particles. In the art and in the specification for this application, the source suspension may be referred to as: low solids suspension, colloidal suspension, liquid suspension, solids suspension, particles suspension, low biosolids suspension, or dilute suspension. In the case of manure, the source suspension may be referred to as manure, liquid manure, low solids manure, manure slurry, or simply “manure”. The solids resulting from the separation may be referred to as biosolids, solids component, solids, manure solids, or low moisture solids as the case may be. Agglomeration is an action by which small colloidal particles coalesce into larger size particles. Agglomeration relates to particle size enlargement, particle joining or particle binding. An effective mechanism to achieve this is by the addition of a coagulant and a flocculant to a particles suspension. Coagulation is the process by which the electrical repulsion between individual particles is reduced, inverted, or neutralized. Flocculation is used to describe the action of polymeric materials which form bridges between individual particles. Bridging occurs when segments of a polymer chain adsorb on different particles and help the particles agglomerate into larger particles. Flocculants have charged groups with a charge that counterbalances the charge of the particles. Flocculants adsorb on the particles and cause destabilization by bridging and/or charge neutralization. The joining and enlargement of these particles continues for as long as the flocculant is present and the system charge favors bridging.

### SUMMARY OF THE INVENTION

The present invention relates to an enhanced, agglomerated fertilizer product comprised of nutrients and inert solids: wherein the nutrients and inert solids are derived from a source material. The nutrients in the source material are collected with a nutrient capture process.

Dewatering minimizes water content. Dewatering is the removal, by intent and design, of water from solid material. It is an object of the present invention for the dewatering process to utilize natural, chemical, or mechanical removal of water from sludge, thereby reducing it to a damp solid with the lowest level of moisture attainable. Technologies include, but are not limited to: wet classification, centrifugation, filtration, or similar solid-liquid separation processes. The percent of solids and moisture in relation to each other after dewatering is dependent on the nature of the sludge and the exact natural, chemical, and/or mechanical means used to dewater the sludge. Sludges that are typically dewatered include, but are not limited to: sludges generated by meat and food processing, municipal waste processing, chemical processing, ceramic manufacturing, porcelain and enamel fabrication, metal plating and finishing, steel mills, paint and paint processes, pharmaceutical manufacturing, grease and septic haulers. There is a known problem in the industry related to some negative economic factors of dewatering. The water that is removed from the solids in dewatering has a level of nutrients remaining in it that makes it prohibitive to land apply at times because of the heavy nutrient load. In addition, the solids resulting from the dewatering process have a lower nutrient content, as some nutrients are being lost in the removed water. From a fertilizer perspective, this lower grade fertilizer is less desirable in the market as a higher application rate is required to achieve desired nutrient loadings, thereby increasing the cost per acre. It is an object of the present invention to create an enhanced fertilizer product that features a higher nutrient content than those derived from just a dewatering process.

Conversely, nutrient capture process maximizes nutrient content. Nutrient capture process is the retaining, by intent and design, of nutrients with solid material. It is an object of the present invention for the nutrients to include those nutrients inherently found in the solids of a dewatering process, and/or some or all of the nutrients inherently found in the water separated in a dewatering process. It is an object of the present invention for the nutrient capture process to utilize physical/mechanical separation, chemical separation and/or electromagnetic separation to retain nutrients with solids, as both are attempted to be removed from sludge, thereby reducing it to a damp solid with the highest level of nutrient attainable. The percent of solids and nutrient in relation to each other after nutrient capture is dependent on the nature of the sludge and the exact nutrient capture process means used. Sludges that are typically used with nutrient capture contain some form of nutrients in the sludge. Nutrient capture economics has a more appealing result than a dewatering process in that the water, freed of many nutrients, can be land applied with significantly less environmental/economic impact. In addition, the resultant solids from the nutrient capture process have a higher nutrient content than the solids from the dewatering process which has more market appeal for land application as a fertilizer product. But, if agglomerated into a marketable fertilizer, as is the object of the present invention, the marketability of the product increases as there is already a significant market for this type of fertilizer, and the fact that this enhanced fertilizer has a greater nutrient content and thereby market appeal.

An enhanced fertilizer product is any fertilizer product that is produced by using any form of nutrient capture process, whether the process is new, an addition, or a modification to an existing source material processing facility. A marketable enhanced fertilizer product that utilizes a nutrient capture process will possess identifiable traits. First, it will be a dry, granular product, containing measureable, and declared fertilizer content/value. These products will also contain a higher amount of fertilizer content than any marketable product derived from the same source material which has only utilized a dewatering process because the use of a nutrient capture process will have captured and retained more nutrients. It is an object of this invention to create an enhanced fertilizer product from any source material using a process that separates liquids from solids, that is intentionally aiming to capture fertilizers and/or nutrients found in separated waste water from a dewatering process. It is also an object of this invention to claim a higher fertilizer/nutrient content on the marketable enhanced fertilizer product. It is also an object of this invention to create a higher fertilizer/nutrient concentration in the solid portion of separated source material, and reduced nutrient content in the waste water portion of the separated source material.

Compost is the end result of aerobic decomposition of organic matter.

It is an object of the present invention for the nutrient capture to be done exclusive of, in series with, or in parallel with dewatering.

Electromagnetic separation is ionic bonding, positive and negative attraction.

An enhanced, agglomerated fertilizer is a fertilizer that has extra nutrient that is derived from a nutrient capture process.

Nutrients include nitrogen, phosphorous, potassium, calcium, magnesium, sulfur, boron, chlorine, copper, iron, manganese, molybdenum, zinc, sodium, silicon, cobalt, vanadium, gypsum and lime.

Inert solids are organic and inorganic solid material other than liquids and nutrients.

Source material is organic wastes, animal wastes, digestion system effluent, ethanol plants, food processing wastes, agricultural wastes, food wastes, municipal wastes, algae, industrial waste, and/or liquid bio fuels (ethanol, methanol, biodiesel).

It is an object of the present invention for the nutrients in the source material to be collected with a dewatering process.

It is an object of the present invention for the dewatering processes to include mechanical separation processes (screens, inclined, vibrating, and rotating; belt presses; centrifuges; screw presses) and/or gravity separation processes (settling basins, dissolved air flotation systems).

It is an object of the present invention for an effluent to be created from the nutrient capture process.

Effluent is wastewater derived after nutrient capture process. It includes water and residual nutrient and/or inert solids.

It is an object of the present invention for the nutrients to be comprised of; captured soluble nutrients, colloidal nutrients, and/or nutrients attached to colloidal suspended solids in the source material.

It is an object of the present invention for the fertilizer to be agglomerated with an agglomeration process including agitation, pressure, liquid and/or thermal. The agitation process includes methods of tumbling, mixing, granulation, palletizing, balling, conditioning, and thermal. The pressure process includes methods of briquetting, compacting, extrusion, pelleting, molding, tabletting, and isostatic pressing. The liquid process includes the methods of spray drying, spray granulation, fluid bed granulation, prilling, agglomeration in liquid media, oil agglomeration and globulation. The thermal process includes methods of sintering, induration, nodulizing, calcining, drying/solidification, partial gasification/charring, and flaking.

It is an object of the present invention for the fertilizer to further comprise added nutrients, pH correction material, other source materials, and/or other inert materials. Added nutrients are nutrients not derived from the source material.

pH correction material is used to correct pH of fertilizer to make either more basic and/or more acidic.

It is an object of the present invention for the source material to be derived from organic wastes, animal wastes, digestion system effluent, ethanol plants, food processing wastes, agricultural wastes, food wastes, municipal waste, algae, industrial waste, and/or liquid bio fuels (ethanol, methanol, biodiesel).

It is an object of the present invention for the product to be comprised of nitrogen, phosphorous, potassium, sulfur, magnesium, calcium, Boron, Copper, Chlorine, Iron, Manganese, Zinc, Cobalt, sodium, silicon, vanadium, gypsum, lime and/or molybdenum.

It is an object of the present invention for the product to consist essentially of phosphorous and nitrogen.

It is an object of the present invention for the nutrient capture process to include one or more chemical additions (generic starches, coagulants).

The present invention relates to an enhanced organic fertilizer product comprised of nutrients and inert solids: wherein the nutrients and inert solids are derived from a source material, and wherein the nutrients in the source material are collected with a nutrient capture process. The fertilizer product is agglomerated and the fertilizer product is organic.

It is an object of the present invention for the fertilizer to have a phosphorous recovery of approximately 75% or greater.

It is an object of the present invention for the fertilizer to have a phosphorous recovery of approximately 90% or greater.

It is an object of the present invention for the fertilizer to comprise a carbon based product that puts carbon back in the soil.

It is an object of the present invention for large particles to be removed using a prescreening process before during or after the nutrient capture process.

It is an object of the present invention for new solids to be added to the nutrient capture process.

It is an object of the present invention for the solids and nutrients from the nutrient capture process, prior to granulation to be added to the source material.

It is an object of the present invention for the fertilizer to be an agglomerate.

It is an object of the present invention for the fertilizer to be a non-agglomerate.

It is an object of the present invention for the fertilizer to have a dryness of approximately 25% moisture or less.

It is an object of the present invention for the product to further comprise a binder.

It is an object of the present invention for the binder to be comprised of: fertilizer, blood, fat, guar, molasses, syrup, rice, starch, juice, polyacrylamide, brewer's waste, distiller's syrup, dry compost, clay, lignon.

It is an object of the present invention for the product to further comprise an additive, the additive comprising a fortification nutrient, polymer, colorant, densification agent, water management agent.

It is an object of the present invention for a digester to be used before, during or after the nutrient capture process.

It is an object of the present invention for the digester to generate digested gas, wherein the digested gas is used to dry the fertilizer.

It is an object of the present invention for the effluent which is absent of nutrients that are captured in the fertilizer to be used for process or land application.

It is an object of the present invention for the dewatering process to be on site or offsite or a combination of both and the product transported to a central location.

It is an object of the present invention for the large particles to be used for bedding, fuel, fertilizer or recycle addition.

It is an object of the present invention for the nutrient capture process to further comprise a composting process.

It is an object of the present invention for the product produced to be at a lower drying cost.

It is an object of the present invention for the product to be produced, marketed and/or sold as an enhanced fertilizer product claiming increased nutrient content that was derived from a nutrient capture process.

It is an object of the present invention for the product to have a value as a carbon credit.

A solid is defined as having at least approximately 85% or less moisture and comprises minerals and organic matter.

Agitation agglomeration can use the following equipment: mixers (planetary, cone, ribbon, pintype, drum, counter-current, vertical, paddle, pugmills); Disc pelletizers (pan granulators), drum pelletizers, and cone pelletizers. Pressure agglomeration can use the following equipment: roller presses (roll briquetters, roll compactors), piston/ram presses, pellet mills (ring die, flat die), extruders (auger, screw, screen, basket), tablet presses. Liquid agglomeration can use the following equipment: spray dryers, prill towers, spray/fluid bed, granulators, mixers for oil agglomeration. Thermal agglomeration can use the following equipment: sinter'strands, traveling grates, rotary kilns, shaft furnaces, and drum/belt flakers.

Agglomerates can also be made via a process of size reduction wherein a material is reduced into smaller particle sizes. In an embodiment, the solid is comprised of materials that are not in a liquid or slurry state.

It is an object of the present invention for the agglomerate to have a dryness of approximately 25% moisture or less.

It is an object of the present invention for the colloidal nutrients to comprise fine solids.

The present invention relates to a chemical composition for the agglomeration of colloidal suspension particles into solids. This composition is a combination of a coagulant and a flocculant that is effective for liquids that comprise organic colloidal solids in the range of about 0.5% to about 30%. When applied in proper dosages, water that is substantially free of these particles is released, and solids, that contain all the beneficial elements of the suspension such as nutrients and minerals, can be easily and speedily separated from the water by mechanical means. The separation provides solids that can be used to take advantage of these beneficial elements, and water that is substantially free of these elements that can be used for industrial purposes or, with additional treatment, can be made potable. The chemical composition is effective in a variety of applications such as cellulose, ethanol bi-products, manure, sugar cane, grain distilled ethanol, and switch grass.

It is an object of the present invention for the coagulant and flocculant to work on contact to separate the solids from the liquids. It is an object of the present invention for the system and process to work on the separation of solids and liquids in municipal sewage sludge.

It is an object of the present invention for the separating of the solids suspension, to comprise 1) applying a chemical composition to treat the colloidal suspension particles to agglomerate them into a solids component and to release water from the suspension, 2) separating continually the water from the solids, and 3) moving continually the water and solids apart from each other.

The steps for continually separating water from the biosolids and moving the water apart from the solids can be accomplished by a variety of mechanical separation devices. These include conveyor paddles, flighted conveyors, stationary sloping screen, a cyclone separator, gravity based separators, piston separators, vibrating screens, belt press, roller press, shaftless spiral conveyors, or rotating screens. A preferred embodiment for a mechanical separation device is a rotating screen combined with a flighted screw ribbon arrangement that allows progressive thickening of the solids suspension through the length of the screw housing while the water drains through the screens and moves the thickened solids towards the exit.

Processing speeds in excess of 400 gal/min, and separation efficiency of up to 98% can be achieved. This means that up to 98% of the beneficial nutrients can be recovered in the biosolids and up to 98% of the solids can be removed from the water effluent.

It is an object of this invention to provide compositions, methods and apparatus suitable for cleaning industrial effluents and bodies of water from impurities and toxins. Examples of uses for this technology are: cleaning river water from sediments, cleanup of PCBs from rivers, cleanup of water from domestic uses such as pools, hot tubs and fish tanks, and cleaning rivers and ground water of fertilizer residue.

It is an object of the present invention to provide manure biosolids suitable for land application for use as a fertilizer with or without the use of water-soluble polyacrylamides to stabilize the soil and its nutrients against erosion, crusting and to minimize water runoff. The biosolids must be chemically stable during the separation process and in handling, but able to break down and release the minerals and nutrients to the soil after the application.

It is an object of the present invention to provide a separation system of solids from water that is continuous and able to proceed at a rapid rate. It is further the object of the present invention to provide a water of potable quality as the product of the separation from manure. It is further the object of the present invention to provide the water effluent product of this separation that is substantially devoid of harmful bacteria to humans, livestock or the environment. It is further the object of this invention to provide biosolids that are devoid of any unpleasant smells.

It is an object of the present invention to provide a secondary water treatment method that allows further water clarification.

It is an object of the present invention to be able to correct the pH of the system by adding additives, for instance, calcium which would raise the pH.

It is an object of the present invention to provide the system to treat a polluted or dirty water system. An example of such a system is a pond which has too much sediment floating in it, or too much fertilizer soluabilized in the water. The system and process of the present invention can be used like a filter system, the dirty water, or water with contaminants in it is pumped from the body of water to the system of the present invention, wherein clean water is returned to the body of water. This same system can be used to assist in treating PCBs in a body of water.

In an embodiment of the present invention, two chemical mechanisms are combined to agglomerate the colloidal suspension particles together and to release water that is relatively free of solids: coagulation and flocculation. Coagulation is the destabilization of colloids by neutralizing the forces that keep them apart. Cationic coagulants provide positive electric charges to reduce the negative charge, or zeta potential, of the colloids. As a result, the particles collide to form larger particles referred to as flocs. Flocculation is the action of polymers to form bridges between the flocs and bind the particles into large agglomerates or clumps. Bridging occurs when segments of the polymer chain adsorb on different particles and help particles aggregate. An anionic flocculant will react against a positively charged suspension, adsorbing on the particles and causing destabilization either by bridging or charge neutralization. In order to effectively flocculate a colloidal suspension, a very high molecular weight polymer, typically greater than 1 million is required. Inter-particle bridging can occur with nonionic, cationic or anionic polymers. Both coagulation and flocculation reactions take place as soon as the chemicals make contact with the suspended particles and are virtually instantaneous. It is to be understood that effective coagulants or flocculants could perform well in and of themselves, however, when combined there is an enhanced synergistic effect.

Many factors determine the effectiveness of coagulation and flocculation. Among these are the nature and charge of the colloidal particles, the length, charge and shape of the polymer chain, and the ionic character of the solution.

The combination of flocculants and coagulants added to a solids suspension accomplishes three functions: 1) the agglomeration of colloidal particles into solids, 2) the release of the water from the suspension and 3) retention of the ionic components such as phosphorous, nitrates, sulfates, potassium ions, and sodium ions. To a great extent flocculants alone can accomplish the separation of solids and water function fairly effectively. The addition of coagulants, however, makes the separation of the ionic particles and their retention onto the solids more effective.

Bivalent cationic oxides and salts are known inorganic coagulants. Examples are calcium chloride, calcium nitrate, calcium sulfate, magnesium chloride, magnesium nitrate, magnesium sulfate, calcium oxide and magnesium oxide. Trivalent cationic oxides and salts perform more effectively than bivalent oxides and salts. Among these are aluminum oxide, aluminum sulfate, aluminum chlorohydrate, aluminum perchloride and ferric chloride. Among the known organic coagulants are quaternary polyamines and PolyDADMAC.

Flocculants are hydrophilic polymers having a molecular weight varying from 1 to 30 million and a degree of polymerization of between 14,000 and 420,000 monomer units. Flocculants are typically acrylamide based. They may be homopolymers and have a nonionic nature or they may be copolymers and have a cationic or anionic nature with a degree of ionization varying between 0 and 100%.

Anionic flocculants are obtained either by hydrolysis of the amide groups on a polyacrylamide chain or by copolymerization of the polyacrylamide with a carboxylic or sulfonic acid salt. The most common type of flocculant made by copolymerization is one between an acrylamide and acrylic acid.

The anionicity of these copolymers can vary between 0% and 100% depending on the ratio of the monomers involved.

The main characteristics of the copolymers are: a molecular weight: 3 to 30 million and a viscosity at 5 g/l: between 200 and 2800 cps.

Cationic flocculants are mainly derived from the copolymerization of acrylamide with dimethylaminoethyl acrylate (DMAEA) in quaternized form.

A first reaction of DMAEA with methyl chloride allows it to be converted into a quaternary ammonium salt in the form of chloromethylated DMEA (DMAEA-MeCI).

The copolymerization of DMAEA-MeCl with acrylamide produces the cationic polymer. The cationic charge of the copolymer is determined by the ratio of each monomer and may vary between 0 and 100%. The ester group of the copolymer is very sensitive to a pH of above 6.0.

Hydrolysis of the polymer reduces its efficiency by creating amphoteric polymers and then anionic polymers. It is therefore essential to prepare these polymers at a pH of about 5.5, even though the flocculation is carried out at a higher pH. However, during flocculation, the floc may be converted by chemical modification of the polymer when the contact times are long, for example during settling.

The main characteristics of the products obtained are: molecular weights ranging from 3 to 10 million, and the viscosity at 5 g/l ranges from 100 to 1700 cps.

In an embodiment, processing manure involves pumping the liquid manure from a lagoon or an anaerobic digester, mixing the liquid manure in line with an effective amount of a coagulant and/or an effective amount of a flocculant and then introducing the liquid manure into a mechanical separation device. A number of designs can be used. These include conveyor paddles, flighted conveyors, stationary sloping screen, a cyclone separator, gravity based separators, piston separators, vibrating screens, belt press, roller press, shaftless spiral conveyors, or rotating screens. A preferred separation device is a rotating screen combined with a flighted screw ribbon arrangement that allows progressive thickening of the manure through the length of the screw housing while the water drains through the screens and moves the thickened manure towards the exit. At the exit, the manure must be thick enough, i.e., at least 25% solids, so that it can be dewatered further by a compressing device such as a press roll, or a belt press. The rotation of the screen provides for the continuous exposure of new screen slots that increases water removal rates and reduces the likelihood of plugging. In a preferred embodiment, the water is drained through slotted screens located at the bottom of the flighting screw housing. The size of the screens can range from about 250 microns to about 4 mm, with the preferred range being about 500 microns to about 1 mm. It is important that the screens be flat and not made of wire for water drainage to be effective. The screen housing is tilted about 5 degrees to about 20 degrees upward to the direction of flow depending on the consistency of the incoming manure. The tilt allows balancing the flow of the solids and the removal of the water through the screens. The manure entering the separation device can be processed in a range from about 0.5-30% solids, however the more typical range is from about 1-5% solids. The manure typically exits the rotating screen housing at about 25-30% solids. It can be further dewatered to around 40-60% solids by pressing with a roller or by other compressing devices.

In the typical separation process, the coagulant and flocculant are each dissolved in a water makeup tank each at a concentration of about 1 g/Kg of water, or about 0.1%, and pumped into the manure separation device. They can be mixed in and pumped from either separate tanks or mixed together and pumped from the same makeup tank. The coagulant should be dissolved in a slightly acidic environment in a pH range of about 6-6.5 preferably using a weak organic acid such as citric acid, and the flocculant dissolved at an ionic strength of 25%. Where a pH adjustment to >7.0 is required for the flocculant, Calcium Oxide can be used.

A multitude of embodiments are disclosed comprising a coagulant and flocculant combination for manure treatment selected from the following list of coagulants and flocculants. It is to be understood that this list is not exhaustive and other coagulants and flocculants may be used in the context of the present invention.

### Inorganic Coagulants

Aluminum Chlorohydrate (Al₃CHOH₅ClOH),
Aluminum sulfate,
Aluminum Perchloride
Aluminum Chloride
Aluminum Nitrate
Ferric Chloride
Calcium oxide
Magnesium oxide
Aluminum oxide
Ferric oxide
Calcium chloride
Calcium nitrate
Calcium sulfate
Magnesium chloride
Magnesium nitrate
Magnesium sulfate

### Organic Coagulants

Polyamines
PolyDADMAC

### Cationic Flocculants

Acrylamide/acryloylethyltrimethylammoniumchloride, or AM/AETAC by short notation, Acrylamide/acrylamidopropyltrimethylammonium chloride or AM/APTAC, and 3-chloro-2-hydroxypropyltrimethylammonium chloride modified starch

### Anionic Flocculants

Acrylamide/sodium acrylate at pH>7
The sodium salt of Acrylamide/2-acrylamidomethylpropanesulfonic acid in the pH range of about 2-12.

The application levels of the coagulant can range from about 1-100 mg/liter of liquid manure, with a preferred range of about 5-50 mg/liter of liquid manure. The application level for the flocculant can range from about 5-75 mg/liter of liquid manure with the preferred range of about 20-50 mg/liter of liquid manure.

Solids separation performance is also enhanced by the addition of fiber to the liquid manure. This fiber provides additional surface area for colloidal particles flocculation. Preferred fibers are straw, bedding, and recycled manure solids and the addition level should range from about 0.5%-5% of liquid manure weight. Performance is likewise enhanced by recycling about 0.5%-5% of the biosolids into the solids separation device.

The water removed from the process typically has less than about 1% solids and with substantially reduced microbe levels compared to the liquid manure. The unpleasant odor of the original manure is also virtually completely neutralized by the chemical treatment. This water, while not potable, is suitable for most agricultural and industrial uses such as irrigation and manufacturing of chemicals. The water can be made potable, however, by further treatment with flocculants in a clarifier.

### BRIEF DESCRIPTION OF THE DRAWINGS

FIG. 1 shows a sketch of the process components for separating liquid manure.

FIG. 2 shows a flow diagram relating to a process for separating liquid manure.

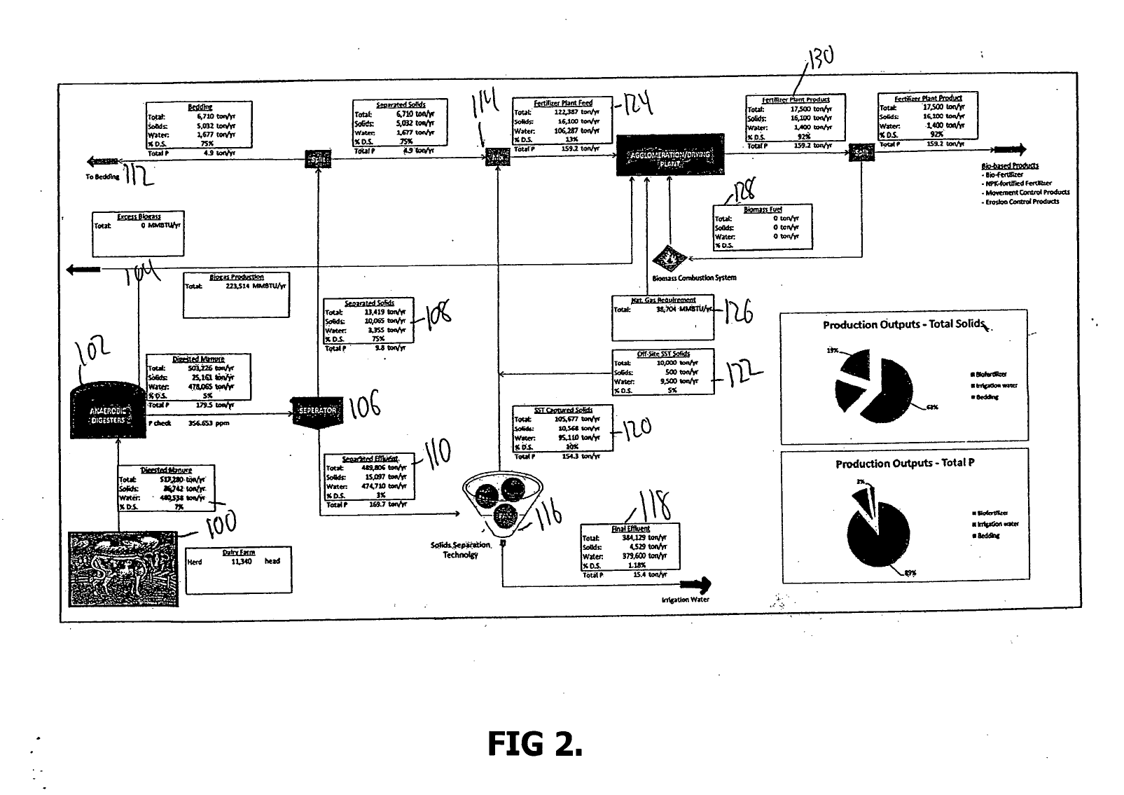

### DETAILED DESCRIPTION OF THE DRAWINGS

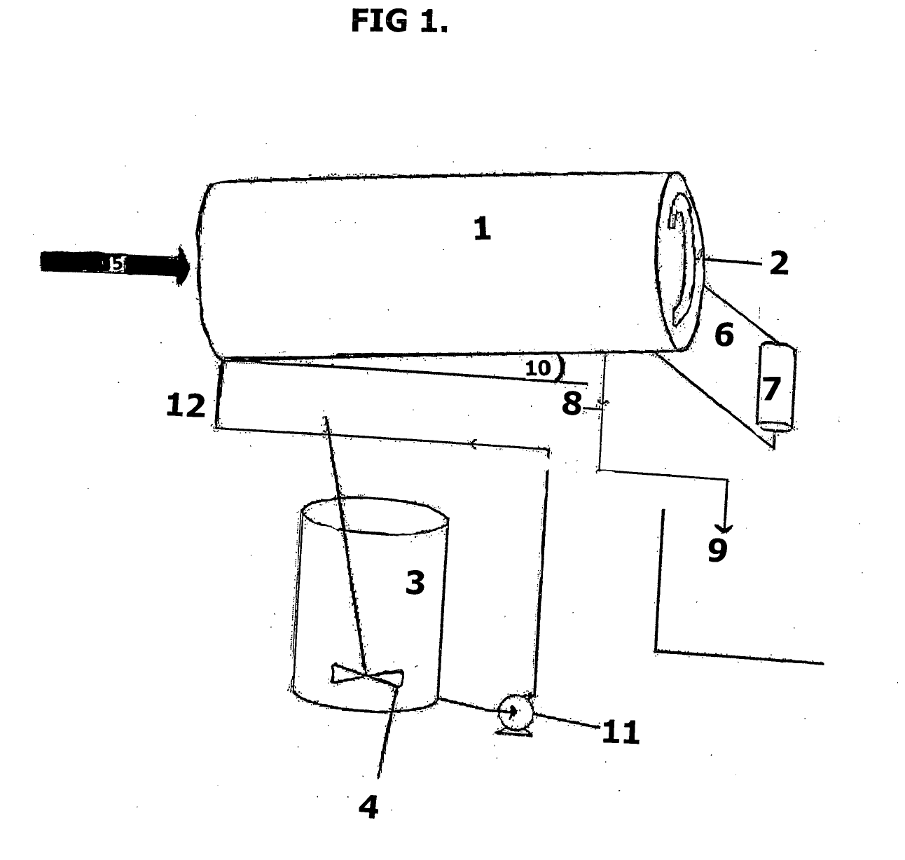

FIG. 1 is a schematic showing the components and the flow of the process. The colloidal suspension feed (5), which may be liquid manure or other such suspensions as described in this application, is pumped into the separation device (1) and is blended with the chemical feed (12). The chemicals are made up in a tank (3) using a mixer (4), and conveyed into the separation device by pump (11). The separation device (1) is a rotating drum having an angle of elevation (10) of about 5-20 degrees relative to horizontal. The bottom of the drum has screen portions through which the water drains (8) into collection tank (9), and a flighting ribbon (2) used for moving the progressively thickened solids to the exit of the separation device (1). The solids exiting the separation device (1) drop onto a hopper (6) from which they are fed under a roll press (7) that further removes water from the solids.

Digested Manure 100 is placed in anaerobic digesters 102. The digested manure has a solids content of approximately 90-95%, and the water content is approximately 5-10%. After the anerobic digester the manure can be used for biogas production 104 or it can be placed in a separator 106. The separator separates the digested manure into a separated solids 108, and a separated effluent 110. Approximately 1-5% of the total weight of the digested manure from the separator becomes separated solids. Of the separated solids approximately 70-80% is solids and approximately 20-30% is water. 95-99% of the digested manure from the separator is separated effluent, of which 1-5% is solids and 95-99% is water.

The separated solids 108 can then either be used for bedding 112 or mixed with other solids from other processes 114 to create fertilizer plant feed.

The separated effluent 110 can then be used for solids separation technology 116. The solids separation technology 116 turns the separated effluent 110 into a final effluent 118 and a SST captured solids 120. The final effluent is approximately 70-85% of the separated effluent product. The final effluent is approximately 95-99% water and 1-5% solids. The SST captured solids is made up of approximately 5-15% solids and 85-95% water.

Off site SST solids 122 made up of approximately 5-15% solids and 85-95% solids can be added to the SST captured solids 120. The SST solids 120 and 122 can then be mixed with the separated solids 114 to create fertilizer plant feed 124.

Biogas production 104, fertilizer plant feed 124, natural gas and biomass fuel 128 can then be used to fuel an agglomeration drying plant, and create fertilizer plant product 130. The fertilizer plant product 130 can be split to create biomass fuel 128 and fertilizer 130.

The fertilizer plant product 130 can be used to create bio-based products, such as bio-fertilizer, NPK fertilizer, movement control products and erosion control products.

We claim:

1. An enhanced fertilizer product comprised of nutrients and inert solids:
wherein said nutrients and said inert solids are derived from a source material;
wherein said nutrients in said source material are collected with a nutrient capture process;
wherein said fertilizer product is agglomerated.

2. The product of claim 1 wherein said nutrients in said source material are also collected with a dewatering process.

3. The product of claim 2 wherein said dewatering processes include mechanical separation processes (screens, inclined, vibrating, and rotating; belt presses; centrifuges; screw presses) and/or gravity separation processes (settling basins, dissolved air flotation systems).

4. The product of claim 1 wherein an effluent is created from said nutrient capture process.

5. The product of claim 1 wherein said nutrients are comprised of; captured soluble nutrients, colloidal nutrients, and/or nutrients attached to colloidal suspended solids in said source material.

6. The product of claim 1 wherein said fertilizer is agglomerated with an agglomeration process including agitation, pressure, liquid and/or thermal;
wherein said agitation process includes methods of tumbling, mixing, granulation, palletizing, balling, conditioning, and thermal;
wherein said pressure process includes methods of briquetting, compacting, extrusion, pelleting, molding, tabletting, and isostatic pressing;
wherein said liquid process includes the methods of spray drying, spray granulation, fluid bed granulation, prilling, agglomeration in liquid media, oil agglomeration and globulation;
wherein said thermal process includes methods of sintering, induration, nodulizing, calcining, drying/solidification, partial gasification/charring, and flaking.

7. The product of claim 1 wherein said fertilizer further comprises added nutrients, pH correction material, other source materials, and/or other inert materials.

8. The product of claim 1 wherein said source material is from organic wastes, animal wastes, digestion system effluent, ethanol plants, food processing wastes, agricultural wastes, food wastes, municipal waste, algae, industrial waste, and/or liquid bio fuels (ethanol, methanol, biodiesel).

9. The product of claim 1 wherein said product is comprised of nitrogen, phosphorous, potassium, calcium, magnesium, sulfur, boron, chlorine, copper, iron, manganese, molybdenum, zinc, sodium, silicon, cobalt, vanadium, gypsum, and/or lime.

10. The product of claim 1 wherein said product consists essentially of phosphorous and nitrogen.

11. The product of claim 1 wherein said nutrient capture process includes one or more chemical additions (generic starches, coagulants).

12. An enhanced organic fertilizer product comprised of nutrients and inert solids:
wherein said nutrients and said inert solids are derived from a source material;
wherein said nutrients in said source material are collected with a nutrient capture process;
wherein said fertilizer product is agglomerated;
wherein said fertilizer product is organic.

13. The product of claim 1 wherein said fertilizer has a phosphorous recovery of approximately 75% or greater.

14. The product of claim 1 wherein said fertilizer has a phosphorous recovery of approximately 90% or greater.

15. The product of claim 1 wherein said fertilizer is comprised of a carbon based product that puts carbon back in the soil.

16. The product of claim 1 wherein large particles are removed using a prescreening process before during or after said nutrient capture process.

17. The product of claim. 1 wherein new solids are added to said nutrient capture process.

18. The product of claim 1 wherein solids and nutrients from said nutrient capture process, prior to granulation are added to said source material.

19. The product of claim 1 wherein said fertilizer is a non-agglomerate.

20. The product of claim 1 wherein said fertilizer has a dryness of approximately 25% moisture or less.

21. The product of claim 1 further comprising a binder.

22. The product of claim 21 wherein said binder is comprised of:
fertilizer, blood, fat, guar, molasses, syrup, rice, starch, juice, polyacrylamide, brewer's waste, distiller's syrup, dry compost, clay, lignon.

23. The product of claim 1 further comprising an additive, said additive comprising a fortification nutrient, polymer, colorant, densification agent, water management agent.

24. The product of claim 1 wherein a digester is used before, during or after said nutrient capture process.

25. The product of claim 24 wherein said digester generates digested gas, wherein said digested gas is used to dry said fertilizer.

26. The product of claim 4 wherein said effluent which is absent of nutrients that are captured in said fertilizer is used for process or land application.

27. The product of claim 2 wherein said dewatering process is on site or offsite or a combination of both and said product transported to a central location.

28. The product of claim 16 wherein said large particles are used for bedding, fuel, fertilizer or recycle addition.

29. The product of claim 1 wherein said nutrient capture process further comprises a composting process.

30. The product of claim 1 wherein said product produced is at a lower drying cost.

31. The product of claim 1 wherein said product is produced, marketed and/or sold as an enhanced fertilizer product claiming increased nutrient content that was derived from a nutrient capture process.

32. The product of claim 1 wherein said product has value as a carbon credit.
